(19) United States
(12) Patent Application Publication
(10) Pub. No.: US 2006/0156395 A1
(43) Pub. Date: Jul. 13, 2006

(54) Security device and terminal and method for their communication

(76) Inventor: Paul Fontaine, Winksele (BE)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 11/166,766

(22) Filed: Jun. 24, 2005

(30) Foreign Application Priority Data
Jun. 25, 2004 (EP) 04447151.4

(51) Int. Cl. H04L 9/32

(52) U.S. Cl. 726/9

(57) ABSTRACT

A device is provided for authorizing the use of a selected function from among at least two functions of the device. The device includes storage for storing a function-specific voice pattern that is linked to the selected function, and a comparator for comparing an external input signal with the function-specific voice pattern. Also provided is a terminal unit for communicating with a device for authorizing use of a selected function of the device, and a communication system that includes a device for authorizing use of a selected function and a terminal unit for communicating with the device. Additionally, there are provided a method for giving a user authorization to use a selected function of a device, and a method for obtaining authorization to use a selected function of a device.

### CROSS-REFERENCE TO RELATED APPLICATIONS

This application is based upon and claims priority from prior European Patent Application No. 04 447 151.4, filed Jun. 25, 2004, the entire disclosure of which is herein incorporated by reference.

### FIELD OF THE INVENTION

The present invention relates to a security device and a terminal, and a method for communication between a security device and a terminal.

### BACKGROUND OF THE INVENTION

Smart cards are used to improve the security of functions like payments, access control, signatures and decryption. The smart cards ensure that these functions can only be performed in the presence of a smart card because the smart cards contain one or more secrets (typically cryptographic keys) that are needed to successfully execute the functions.

To avoid the use of the smart cards by an illegitimate user, a passphrase that controls access to the smart card is used. The functions of the card are blocked as long as the passphrase is not validated by the smart card. The most commonly used passphrase for smart cards is a PIN. That PIN should be known by the cardholder only and is used by the card to verify the presence of the legitimate cardholder. The smart card has a mechanism to avoid an illegitimate user guessing the PIN. For example, after three successive incorrect PINs have been sent to the smart card, the smart card refuses to operate.

To avoid misuse of the secrets by a terminal in the absence of the card, these secrets are kept in the card and are never given to the terminal. The PIN only authorizes the terminal to use card functions that use these secrets.

When entering the PIN on the keyboard of a terminal (this can be for example a PC, an EFT POS terminal or a bank terminal), the PIN is read by the program running on the terminal and is sent to the smart card. The smart card can verify if the PIN is correct. If the PIN is accepted by the smart card, the terminal can use any smart card function (see FIG. 1). As long as the PIN is not verified, asking the smart card to perform a function will fail.

Current smart cards can contain more than one function. It is the task of the terminal to make clear to the cardholder which function of the smart card will be used. It is also possible that the terminal asks the cardholder to select the function he wants to use. For example, a multi-function smart card can implement secure functions for access control and payments. When a cardholder wants access to a website with a smart card based access control function, he enters his smart card in a PC and enters his PIN. When the same user wants to make a payment, he uses the same smart card and PIN to authorize the payment.

However, the terminal may fool the cardholder by doing something different than expected. When the cardholder enters his PIN with the assumption that the terminal will use a specific function of the smart card, the terminal might very well be using another function of the smart card and executing an operation that the user did not ask for. The cardholder may for example use his smart card and his PIN on a PC in an Internet cafe to gain access to his e-mail. However, the PC uses the smart card and the PIN to do a payment that the cardholder did not expect. This payment can even be done without informing the cardholder.

The risk of such a problem is important because the terminal does not belong to the cardholder and may be modified by whoever has access to the terminal and wants to commit fraud. A smart card however is easier to trust because it belongs to the cardholder and is designed to be difficult to modify.

A possible solution for this problem can be that each function on the smart cards has a different PIN. The user decides which function of the smart card he wants to use, and enters the PIN for this specific function. If the terminal uses the PIN with the wrong function of the smart card, the smart card will refuse it (because this function requires a different PIN). In this way a PIN is reserved to a function, and a terminal cannot use a function that the user did not authorize. For example, the cardholder wants to access his e-mail using a PC. He enters PIN “1234” because this is the PIN linked to the e-mail access authorization. The PC tries to perform a payment with the same PIN and card without approval of the cardholder, but the smart card refuses the transaction because the PIN for a payment is different. Instead of reserving a different PIN for each function, a number of functions can also share the same PIN.

A major limitation of the above-mentioned solutions is that the cardholder has to remember many different PINS. In practice, the user will be tempted to use the same PIN instead of different values for many functions. Another limitation is that it increases the possibilities for guessing a PIN. If a card has two different functions, each with a different PIN and three attempts on each PIN, the total number of PIN attempts to guess the PIN of a card becomes six instead of three.

EP-A-0 886 246 tackles more or less the same problem. It preferably makes use of a telephone line to transmit the voice signal. As opposed to the solution of the present invention, it employs an external calculator to derive voice characteristics and check with the stored voiceprint. Similarly, in the approach of Feustel et al. (U.S. Pat. No. 4,827,518) the comparison of spoken word and recorded pattern is performed on the terminal. Also in GB 2 139 389 A the card reader and the comparator are united. In ES 21114493 and DE 197 10 664 the comparison takes place outside the smart card. In U.S. Pat. No. 4,851,654 the pronounced voice signal is processed on the smart card and subsequently output.

GB 2 386 803 A discloses a system having a token and a token reader. The comparison of stored pattern and pronounced sample can be performed by the token reader, but may alternatively also be performed within the token. It is mainly directed to the security of a digital signature.

In patent application WO 03/021539 A1 a portable device is disclosed that is arranged for comparing the detected signal characteristics with voice characteristics that are stored in a memory of the portable device. The device includes an authentication function and, once authorization is obtained, allows the selection of a further function, as the memory may include preloaded voice sequences belonging to one or more legitimate users where each preloaded voice sequence corresponds to a command that is recognized by the processor. When during the initial authentication step the voice recognition code detects a match between a command spoken by a user and a sequence preloaded into the memory, authorization is granted to the user and the processor may execute a predefined sequence or task corresponding to the command. This feature of selecting a function in a device using pattern recognition after an authentication step has been performed is however not used in present invention.

### SUMMARY OF THE INVENTION

It is an object of the present invention to provide an improved security device with selective authorization of functions which will avoid use by an illegitimate user.

Another object of the present invention is to provide a terminal unit for communicating with such a security device.

A further object of the present invention is to provide a method for communicating between such a security device and such a terminal.

One embodiment of the present invention provides a device for authorizing use of a selected function from among at least two functions of the device. The device includes storage for storing a function-specific voice pattern that is linked to the selected function, and a comparator for comparing an external input signal with the function-specific voice pattern.

Another embodiment of the present invention provides a terminal unit for communicating with a device for authorizing use of a selected function of the device. The device stores a function-specific voice pattern that is linked to the selected function. The terminal unit includes a receiver interface for interfacing with the device, a selector for allowing selection of a function as the selected function, and a voice message receiver for receiving a voice message. The terminal unit also includes a processor for processing the voice message, and a transmitter for sending the processed message to the device for comparison with the voice pattern that is linked to the selected function.

A further embodiment of the present invention provides a method for giving a user authorization to use a selected function of a device that stores a function-specific voice pattern that is linked to the selected function. According to the method, the device is received at a receiving interface of a terminal unit, and an identifier that is pronounced by the user is received. The identifier corresponds to the selected function. The pronounced identifier is processed in the terminal unit, and the processed identifier is sent to the device for comparison with the voice pattern that is linked to the selected function. Based on a result of the comparison by the device, there is received from the device either an authorization grant that allows use of the selected function, or an authorization denial that denies access to the selected function.

Yet another embodiment of the present invention provides a method for obtaining authorization to use a selected function of a device that stores a function-specific voice pattern that is linked to the selected function. According to the method, the device is interfaced with a terminal unit, and an identifier that corresponds to the selected function is pronounced. After recognition by the device of the voice pattern of the pronounced identifier, authorization to use the selected function is obtained.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 represents a conventional solution.

FIG. 2 represents a solution according to a preferred embodiment of the present invention.

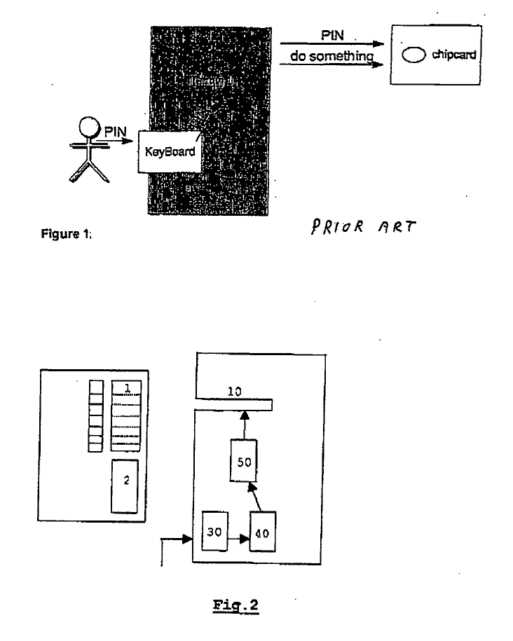

### DETAILED DESCRIPTION OF PREFERRED EMBODIMENTS

Preferred embodiments of the present invention will be described in detail hereinbelow with reference to the attached drawings.

Embodiments of the present invention use biometrics, and more specifically voice recognition, instead of (or in addition to) using a PIN to give access to a function on a smart card. Biometric voice recognition does not use the actual value of a spoken word, but the way it is pronounced by a specific person. This way the passphrase (being a pronounceable word) does not have to be secret. Someone else who sees or hears it is not capable of pronouncing it exactly the way the legitimate user pronounces it. Because the word itself is not secret, the protection lies in how the legitimate user pronounces it.

One embodiment of the present invention provides a device for authorizing the use of a selected function from among at least two functions provided on the device. The device comprises storing means for storing a function-specific voice pattern that is linked to the selected function, and comparing means for comparing an external input signal with the function-specific voice pattern.

In a preferred embodiment, the function-specific voice pattern corresponds to an identifier that is a word, a combination of words or a phrase to be pronounced by a legitimate user of the device. Optionally, the device includes identifier storing means.

Preferably, the device includes PIN code storing means for accessing a selected function provided on the device.

In some embodiments, the device includes additional passphrases storing means for accessing a selected function provided on the device.

In a typical embodiment, the device is a smart card.

Another embodiment of the present invention provides a terminal unit for communicating with such a device. The terminal includes receiving means for receiving the device, selection means for selecting a function, voice message recording means, processing means for the recorded voice message and communication means for sending the processed message to the device.

Preferably, the terminal unit further includes function reading means for reading the at least two functions provided on the device. Optionally, the selection means are for selecting a function from among at least two functions.

In one embodiment, the terminal unit includes identifier storing means, with the identifier being a word, a combination of words or a phrase to be pronounced by a legitimate user.

The present invention also provides a communication system that includes such a device and such a terminal unit.

Yet another embodiment of the present invention provides a method for giving a user authorization to use a selected function that is provided on such a device, with the device being in communication with such a terminal unit. According to the method, the device is received in a terminal unit, and the user is pronounces an identifier corresponding to the selected function (for example, at the request of the terminal unit). The pronounced identifier is processed, and the processed identifier is sent to the device. It is verified on the device whether the processed identifier corresponds to the voice pattern specific for the selected function. Authorization to use the selected function is granted in the case of a positive verification, or access to the selected function is denied in the case of a negative verification.

Preferably, a PIN code is also checked to gain access to the selected function.

In one embodiment, the selected function is determined by the user (for example, at the request of the terminal unit), after the device is received. In another embodiment, the selection of the function is performed before the device is received.

In some embodiments, additional passphrases are checked to gain access to the selected function.

In one specific embodiment, the terminal unit displays the identifier corresponding to the function to be used. The terminal unit may obtain the identifier corresponding to the function to be used from the device.

A further embodiment of the present invention provides a method for obtaining authorization to use a function provided on such a device, with the device being in communication with such a terminal unit. According to the method, the device is entered into a terminal unit, and there is selected a function to be authorized. An identifier corresponding to the selected function is pronounced (for example, at the request of the terminal unit). After recognition by the device of the voice pattern of the pronounced identifier, authorization to use the selected function is obtained.

Preferably, a PIN code is also used to gain access to the selected function.

In one embodiment, additional passphrases are used to gain access to the selected function.

FIG. 2 shows a solution according to a preferred embodiment of the present invention. In this embodiment, each function of the smart card has a different voice pattern linked to it. For both the cardholder and the card this pattern represents a specific function. The cardholder is asked (explicitly or implicitly) to pronounce a word to gain access to a function. The smart card only allows the function after recognition of a voice pattern linked to the function. Comparing means 2 are provided for this purpose. For example, when sending the spoken word “signature” to a “digital signature” function of a smart card, this gives access to this function, and cannot be used to obtain access to another function of the smart card.

The device handles secrets, typically cryptographic keys, and is protected against disclosure of these secrets. The physical and logical protection mechanisms used for the secret protection can also be used to protect the function specific voice patterns in the device against modification.

The function-specific voice pattern stored in the device must not be modifiable by an illegitimate person. The device therefore implements access control to the voice pattern storing means 1. One logical access control implementation uses one time programmable memory, so that the information cannot be modified after it has been written the first time. Another logical access control implementation uses authorization control to write data in the device. The authorization may be based on PINs, passwords, voice recognition and cryptography in any combination. One way to implement the physical access control is the use of chips for smart cards or USB security dongles.

The function specific voice patterns can be put in the device in numerous ways. It can be done during a registration process in a trusted environment where the legitimate user pronounces the required identifiers. A trusted terminal device processes the pronounced identifiers and communicates the result together with the required access control information to the device where the results can again be processed before being stored.

Embodiments of the present invention do not use a biometric sensor (microphone) in the device itself to prevent fraud because this is difficult and expensive to manufacture and because it does not prevent the fraudulent use of recorded voice on stolen devices.

The approach of the present invention has several advantages. The word that the cardholder is asked to pronounce can match the function that he wants to authorize. This is easy to explain to the cardholder and easy to remember for the cardholder. Further, the terminal cannot perform functions other than those authorized by the cardholder. Another practical advantage of having several functions on the same card is, from the user's point of view, that one does not need separate cards for various functions like electronic wallet, building access, digital signature, etc. By first selecting a function using a terminal and subsequently authenticating by recognizing a pattern, a quality enhancement is achieved in that the processor does not have to authenticate a person and recognize a command at the same time. It only has to authenticate a person with a pattern corresponding to a command that was already selected before. The approach according to the present invention can reduce the number of false rejects or false accepts in a substantial way.

Using this principle, instead of having to remember a PIN per function, the user has to remember an easy-to-remember word (e.g., the name of the function). The word corresponding to the function may be stored in the terminal. This makes it possible to show the word the user has to pronounce on the screen of the terminal. Another extension is to store the words to be pronounced in the smart card. This makes the terminals more independent. After a cardholder has selected a terminal function and inserted his smart card in receiving means 10 (in any order), the terminal may ask the card to provide the word corresponding to the function of the card. For example, with an e-mail terminal in an international airport, all users may understand English, but have a different word linked to a card function. When the cardholder inserts his smart card, the terminal requests the “text” corresponding to the e-mail function from the smart card. The smart card responds with “courriel” for a French customer and “brievenbus” for a Dutch customer. The terminal requests the cardholder to pronounce that text. By choosing words that mean something, the user is better capable of knowing exactly what will be done once he pronounces the passphrase (thus, which function he will open and what can be done with it).

As another example, the cardholder uses a PC mouse to instruct the PC he wants to access his e-mail. The PC asks him to pronounce “e-mail”. The cardholder pronounces “e-mail”. The PC records it with a recording means 30, processes it with a processing means 40 and transmits the processed voice recording and the e-mail function selection to the smart card via a communication means 50. The smart card verifies that the “e-mail” recording corresponds to the “e-mail” pattern linked to its “e-mail” function. The card authorizes the e-mail function of the card. In this example the terminal cannot perform a function different from e-mail if the cardholder did not pronounce the words corresponding to this other function.

Also, recorded voice samples cannot be used for all functions of the card. In order to prevent illegitimate use of voice recordings, users can refrain from pronouncing certain words in an environment they do not trust. For example, they do not pronounce the word “signature” outside the office in order to prevent the use of the signature function even if the card is used (and the voice recorded), then stolen outside the office.

The word may be replaced with a combination of words or a phrase. When a user pronounces “Purse Load”, the terminal converts the spoken word into digital format and sends it to the Purse Load function in a smart card. The Purse Load function verifies if this password is really “Purse Load” pronounced by the legitimate user. If so, the Purse application can be used. If the verification fails, the Purse Load function remains closed.

In addition to the voice patterns of each card function, a PIN can be used. Since PIN and voice recognition serve different purposes, it can be explained to cardholders that they need both a PIN and a voice pattern to access functions. Since the PIN increases the authorization confidence, the recognition requirements can be lowered, thus lowering false rejection.

In another embodiment additional passphrases are used for one function. Each passphrase imposes specific limits where the function allows such limits. An example of this is the signing money transfer function. The problem is again the same. The user does not see what happens inside the terminal. If he wants to transfer ε1,000, he can give his voice passphrase for the money transfer function (e.g., “Money Transfer”) . The terminal sends this spoken password to the smart card, and has access to the money transfer function, but there is no proof that because the terminal shows on the screen “ε1,000”, that this amount is actually sent to the smart card. A fraudulent terminal can ask the smart card for a money transfer of ε100,000. The solution is to give the same smart card function more than one passphrase. In our example with the money transfer function, they can be:

“Money Transfer”,

“Money Transfer maximum one thousand”, and

“Money Transfer maximum one million”.

Depending on which passphrase is received, the function only allows money below a specific amount (in our example, the first password allows only money transfers smaller than ε100 (the default), the second one smaller than ε1,000, and the third smaller than one million).

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A device for authorizing use of a selected function from among at least two functions of the device, the device comprising:
storage for storing a function-specific voice pattern that is linked to the selected function; and
a comparator for comparing an external input signal with the function-specific voice pattern.

2. The device as defined in claim 1, wherein the function-specific voice pattern corresponds to an identifier that is a word, a combination of words, or a phrase to be pronounced by a legitimate user of the device.

3. The device as defined in claim 2, further comprising identifier storage for storing the identifier.

4. The device as defined in claim 1, further comprising PIN code storage for storing a PIN code that is necessary for accessing the selected function of the device.

5. The device as defined in claim 1, further comprising additional passphrase storage for storing at least one additional passphrase that is necessary for accessing the selected function of the device.

6. The device as defined in claim 1, wherein the device is a smart card.

7. A terminal unit for communicating with a device for authorizing use of a selected function of the device, the device storing a function-specific voice pattern that is linked to the selected function, the terminal unit comprising:
a receiver interface for interfacing with the device;
a selector for allowing selection of a function as the selected function;
a voice message receiver for receiving a voice message;
a processor for processing the voice message; and
a transmitter for sending the processed message to the device for comparison with the voice pattern that is linked to the selected function.

8. The terminal unit as defined in claim 7, wherein the selector allows selection of one function from among at least two functions of the device.

9. The terminal unit as defined in claim 8, further comprising a function reader for reading the at least two functions from the device.

10. The terminal unit as defined in claim 7, further comprising identifier storage for storing an identifier, the identifier being a word, a combination of words, or a phrase to be pronounced by a legitimate user.

11. The terminal unit as defined in claim 7, wherein, based on a result of the comparison by the device, the receiver receives from the device either an authorization grant that allows use of the selected function, or an authorization denial that denies access to the selected function.

12. A communication system comprising:
a device for authorizing use of a selected function from among at least two functions of the device; and
a terminal unit for communicating with the device, wherein the device includes:
storage for storing a function-specific voice pattern that is linked to the selected function; and
a comparator for comparing the function-specific voice pattern with a processed message that is received from the terminal unit, and
the terminal unit includes:
a receiver interface for interfacing with the device;
a selector for allowing selection of one of the functions of the device as the selected function;
a voice message recorder;
a processor for processing the recorded voice message; and
a transmitter for sending the processed message to the device.

13. A method for giving a user authorization to use a selected function of a device, the device storing a function-specific voice pattern that is linked to the selected function, the method comprising the steps of:
receiving the device at a receiving interface of a terminal unit;
receiving an identifier that is pronounced by the user, the identifier corresponding to the selected function;
processing the pronounced identifier in the terminal unit;
sending the processed identifier to the device for comparison with the voice pattern that is linked to the selected function; and
based on a result of the comparison by the device, receiving from the device either an authorization grant that allows use of the selected function, or an authorization denial that denies access to the selected function.

14. The method as defined in claim 13, further comprising the steps of:
comparing on the device the processed identifier with the voice pattern that is linked to the selected function; and
sending the authorization grant to the terminal unit if there was a positive comparison, or sending the authorization denial to the terminal unit if there was a negative comparison.

15. The method as defined in claim 13, further comprising the step of receiving a PIN code that is necessary for gaining access to the selected function.

16. The method as defined in claim 13, further comprising the step of receiving a selection of the selected function from the user, after the step of receiving the device.

17. The method as defined in claim 13, further comprising the step of receiving a selection of the selected function from the user, before the step of receiving the device.

18. The method as defined in claim 13, further comprising the step of receiving at least one additional passphrase that is necessary for gaining access to the selected function.

19. A method for obtaining authorization to use a selected function of a device, the device storing a function-specific voice pattern that is linked to the selected function, the method comprising the steps of:
interfacing the device with a terminal unit;
pronouncing an identifier that corresponds to the selected function; and
after recognition by the device of the voice pattern of the pronounced identifier, obtaining authorization to use the selected function.

20. The method as defined in claim 19, further comprising the step of selecting a function to be the selected function at the request of the terminal unit.

21. The method as defined in claim 19, further comprising the step of providing a PIN code that is necessary for gaining access to the selected function.

22. The method as defined in claim 19, further comprising the step of providing at east one additional passphrase that is necessary for gaining access to the selected function.
